(19) United States
(12) Patent Application Publication
(10) Pub. No.: US 2011/0045253 A1
(43) Pub. Date: Feb. 24, 2011

(54) CONTROL OF PROPERTIES OF PRINTED ELECTRODES IN AT LEAST TWO DIMENSIONS

(75) Inventors: Christian S. Nielsen, River Falls, WI (US); Joachim Hossick-Schott, Minneapolis, MN (US); John D. Norton, New Brighton, MN (US)

Correspondence Address: Medtronic, Inc., 710 Medtronic Parkway, Minneapolis, MN, 55432, US

(73) Assignee: Medtronic, Inc., Minneapolis, MN (US)

(21) Appl. No.: 12/677,126

(22) PCT Filed: Jul. 11, 2008
(86) PCT No.: PCT/US2008/008531

§ 371 Date: Nov. 9, 2010

Related U.S. Application Data
(60) Provisional application No. 60/949,433, filed on Sep. 10, 2007.

(51) Int. Cl. H01M 4/04; H01M 4/58; B05D 5/12

(52) U.S. Cl. 428/195.1; 427/78

(57) ABSTRACT

A method including printing a layer of an electrode on a substrate is described. Printing the layer may include ejecting a first coating composition and a second coating composition from a nozzle. The first coating composition may comprise at least a first coating material and the second coating composition may comprise at least a second coating material. The first coating composition and the second coating composition are introduced over the substrate. An electrode comprising a layer printed on a substrate wherein the layer comprises a first coating material and a second coating material is also described.

### TECHNICAL FIELD

The present disclosure relates techniques of forming a layer of an electrode by printing a coating on a substrate.

### BACKGROUND

Electrodes are used in a wide variety of applications, including, for example, batteries, capacitors, sensors and electrical stimulation systems, such as neurostimulators, implantable cardioverter/defibrillators (ICDs) and the like. The electrode contacts a nonmetallic part of a circuit, such as an electrolyte in a battery or electrolytic capacitor, or body tissue, in a neurostimulator or ICD. In some embodiments, the electrode may include a complex geometry, including, for example, non-planar surfaces, ridges, creases, or the like.

### SUMMARY

In general, the present disclosure is directed to techniques for printing a layer of an electrode on a substrate with control of at least one property of the layer at each of a plurality of locations in the layer. In some embodiments, the at least one property of the layer may include an electrical conductivity, a thermal conductivity, a mechanical property, a power capability, an energy density, a chemical activity or an electrochemical activity. The at least one property may be controlled by controlling a relative amount of a first coating material and a second coating material at each of the plurality of locations in the layer. In some embodiments, the first and second coating materials are ejected out of a single nozzle, either substantially simultaneously or sequentially. In other embodiments, the first coating material is ejected out of a first nozzle, while the second coating material is ejected out of a second nozzle.

In one aspect, the disclosure is directed to a method including printing a layer of an electrode on a substrate. Printing the layer includes ejecting a first coating composition and a second coating composition from a nozzle. The first coating composition may comprise at least a first coating material and the second coating composition may comprise at least a second coating material. The first coating composition and the second coating composition are deposited on the substrate. Printing the layer further includes controlling at least one of an electrical conductivity, a thermal conductivity, a mechanical property, a power capability, an energy density, a chemical activity and an electrochemical activity of the layer by controlling a relative amount of the first coating material and the second coating material at each of a plurality of locations within the layer.

In some embodiments, the method may include printing a layer of an electrode on a substrate, and printing the layer may include ejecting a first coating composition from a nozzle and ejecting a second coating composition from the nozzle. The first coating composition may comprise at least a first coating material and the second coating composition may comprise at least a second coating material. The first coating composition and the second coating composition are deposited on the substrate. Printing the layer may further include controlling at least one of an electrical conductivity, a thermal conductivity, a mechanical property, a power capability, an energy density, a chemical activity and an electrochemical activity of the layer by controlling a relative amount of the first coating material and the second coating material at each of a plurality of locations within the layer.

In other embodiments, the method may include printing a layer of an electrode on a substrate, and printing the layer may include ejecting a first coating composition from a first nozzle and ejecting a second coating composition from a second nozzle. The first coating composition may comprise at least a first coating material and the second coating composition may comprise at least a second coating material. The first coating composition and the second coating composition are deposited on the substrate. Printing the layer may further include controlling at least one of an electrical conductivity, a thermal conductivity, a mechanical property, a power capability, an energy density, a chemical activity and an electrochemical activity of the layer by controlling a relative amount of the first coating material and the second coating material at each of a plurality of locations within the layer.

In some embodiments, the plurality of locations are arrayed in at least two dimensions within the layer, and may be arrayed in three dimensions within the layer.

In some embodiments, the method includes controlling the relative amount of the first coating material and the second coating material at each of the plurality of locations within the layer such that the relative amount of the first coating material and the second coating material varies substantially continuously in at least a portion of the layer.

In another aspect, the disclosure is directed to an electrode including a layer printed on a substrate. The layer comprises a first coating material and a second coating material. At least one of an electrical conductivity, a thermal conductivity, a mechanical property, a power capability, an energy density, a chemical activity and an electrochemical activity of the layer is different in a plurality of locations within the layer. The at least one of the electrical conductivity, the thermal conductivity, the mechanical property, the power capability, the energy density, the chemical activity and the electrochemical activity of the layer is controlled by a relative amount of the first coating material and the second coating material at each of the plurality of locations within the layer.

In some embodiments, the plurality of locations are arrayed in at least two dimensions within the layer, and may be arrayed in three dimensions within the layer.

In some embodiments, the relative amount of the first coating material and the second coating material varies substantially continuously within at least a portion of the layer.

In another aspect, the disclosure is directed to a method including introducing a first material and a second material over a substrate to form a layer of an electrode. The method further includes controlling at least one of an electrical conductivity, a thermal conductivity, a mechanical property, a power capability, an energy density, a chemical activity and an electrochemical activity of the layer by controlling a relative amount of the first material and the second material at each of a plurality of locations within the layer. The first material may include SVO and the second material may include at least one of CH₃F, CH₂F₂, CHF₃, and CF₄.

In yet another aspect, the disclosure is directed to a computer-readable medium comprising instructions that cause a processor to introduce a first material and a second material over a substrate to form a layer of an electrode. The instructions also cause the processor to control at least one of an electrical conductivity, a thermal conductivity, a mechanical property, a power capability, an energy density, a chemical activity and an electrochemical activity of the layer by controlling a relative amount of the first material and the second material at each of a plurality of locations within the layer. The first material may include SVO and the second material may include at least one of CH₃F, CH₂F₂, CHF₃, and CF₄.

In a further aspect, the disclosure is directed to a method including introducing a first material and a second material over a substrate to form a layer of an electrode for a battery in an implantable medical device. The method also includes controlling at least one of an electrical conductivity, a thermal conductivity, a mechanical property, a power capability, an energy density, a chemical activity and an electrochemical activity of the layer by controlling a relative amount of the first material and the second material at each of a plurality of locations within the layer. The first material may include SVO and the second material may include at least one of CH₃F, CH₂F₂, CHF₃, and CF₄.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a conceptual line diagram that depicts an exemplary system for printing a layer of an electrode.

FIG. 1A is a cross-sectional side view of the exemplary electrode shown in FIG. 1.

FIG. 2 is a conceptual line diagram that depicts another exemplary system for printing a layer of an electrode.

FIG. 3 is a conceptual line diagram that depicts another exemplary system for printing a layer of an electrode.

FIG. 4 is a conceptual diagram of an exemplary electrode.

FIG. 5 is a cross-sectional diagram of another example electrode.

FIG. 6 is a conceptual diagram of an exemplary electrode array.

FIG. 7 is a conceptual diagram of an exemplary electrode array.

FIG. 8 is a conceptual diagram of an exemplary segmented electrode.

FIG. 9 is a flow diagram illustrating an exemplary technique of printing an electrode.

FIG. 10 is a flow diagram illustrating another exemplary technique of printing an electrode.

### DETAILED DESCRIPTION

In general, the present disclosure is directed to techniques for printing a layer of an electrode on a substrate with control of at least one property of the layer at each of a plurality of locations in the layer. In some embodiments, the at least one property of the layer may include an electrical conductivity, a thermal conductivity, a mechanical property, a power capability, an energy density, a chemical activity or an electrochemical activity. The at least one property may be controlled by controlling a relative amount of a first coating material and a second coating material that is printed at each of the plurality of locations in the layer. In some embodiments, the first and second coating materials are ejected out of a single nozzle, either substantially simultaneously or sequentially. In other embodiments, the first coating material is ejected out of a first nozzle, while the second coating material is ejected out of a second nozzle.

The first coating material and second coating material may be carried in a fluid carrier or fluid solvent and may be printed according to drop-on-demand or continuous-type fluid emission. In drop-on-demand fluid emission, discrete drops of fluid are ejected by a nozzle in response to a command from a controller. The drops may be formed thermally, mechanically or acoustically, for example, as described in further detail below. In continuous-type fluid emission, a substantially continuous stream of fluid, which may be in the form of a plurality of droplets such as a mist, is emitted from the nozzle and directed to a location of the substrate by positioning the nozzle relative to the substrate.

According to one embodiment of the present disclosure, the nozzles may perform thermal ink jet printing. In thermal ink jet printing, a small resistor proximate an aperture of the nozzle heats and boils a small volume of fluid so that a bubble of the fluid rapidly ejects from the aperture. The bubble of fluid includes the coating material(s) and is directed to a position on the substrate by controlling a relative position of nozzle and the substrate.

Other forms of printing are also contemplated, including, for example, piezoelectric fluid ejection from a nozzle, in which an electrical signal pulses through a piezoelectric material adjacent an aperture and causes the material to flex so that a volume of fluid is ejected from the aperture. Piezoelectric fluid ejection may be favored in the event that the fluid should not be heated or boiled. For example, if a polymeric ink or fluid containing the coating material is used, the performance of a nozzle in a thermal ink jet printing process may be expected to suffer compared to a piezoelectric nozzle, because the fluid may polymerize around the aperture of the nozzle. By comparison, a “cold fluid” piezoelectric printing process tends to eject a polymeric fluid more readily and consistently.

Acoustically-activated printing may also be used in the practice of the techniques described herein. In this form of printing, a source of acoustic energy operatively couples to a vessel adjacent an aperture, which contains a small volume of fluid. When acoustic energy is applied to the volume of fluid, a droplet or droplets of the fluid are ejected from the adjacent the aperture.

Further details regarding printing a layer of an electrode may be found in commonly-assigned U.S. patent application Ser. No. 10/903,685 to Hossick-Schott et al., commonly-assigned U.S. patent application Ser. No. 10/816,795 to Hossick-Schott, and commonly-assigned U.S. patent application Ser. No. 10/817,324 to Hossick-Schott, the entire contents of which are incorporated herein by reference in their entirety.

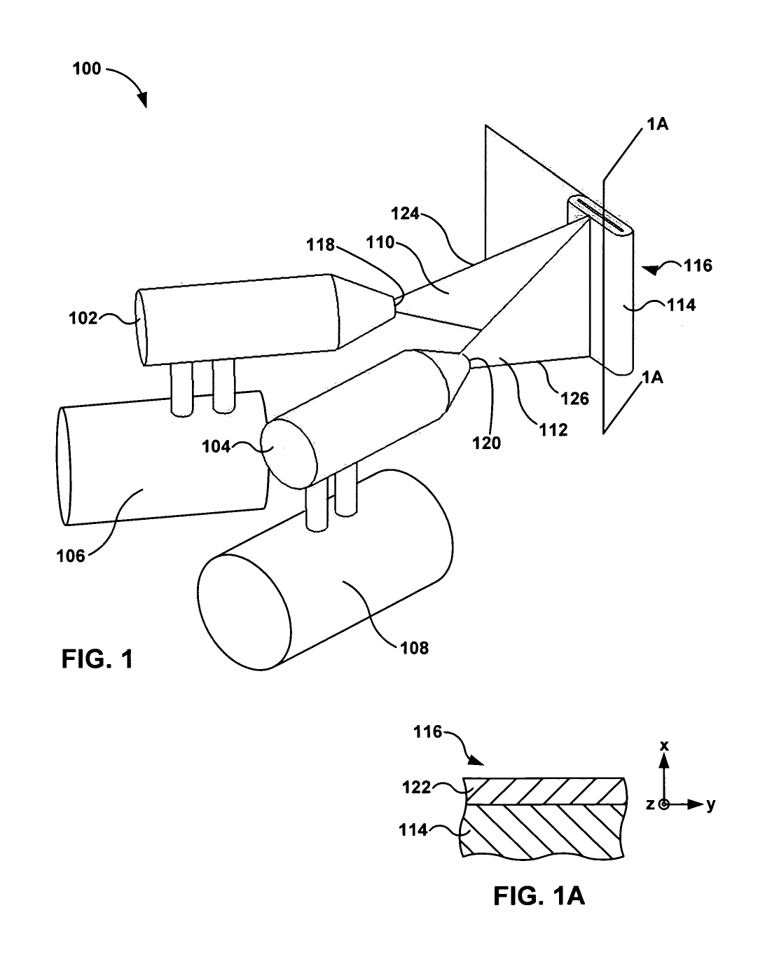

FIG. 1 is a conceptual line diagram illustrating an exemplary system 100 for printing a layer of an electrode 116 on a substrate 114. System 100 includes a first nozzle 102 and a second nozzle 104. First nozzle 102 is fluidically coupled to a first reservoir 106, which contains a first coating composition 110 that is ejected through first nozzle 102. Similarly, second nozzle 104 is fluidically coupled to second reservoir 108, which contains a second coating material 112 that is ejected through second nozzle 104. Each of first coating composition 110 and second coating composition 112 may include at least one coating material carried a fluid carrier or dissolved in a solvent, as will be described in further detail below. The coating materials in first coating composition 110 and second coating composition 112 may be the same or different.

While system 100 in FIG. 1 is depicted as including two nozzles 102 and 104, in other embodiments, system 100 may include three or more nozzles. Further, while the embodiment illustrated in FIG. 1 includes first and second coating compositions 110 and 112, in other embodiments, at least three coating compositions may be utilized. For example, the system may include four nozzles, and each nozzle may fluidically couple to a reservoir. In some embodiments, two or more nozzles may fluidically couple to a single reservoir, while in other embodiments, each nozzle fluidically couples to a respective reservoir. In some embodiments, each of the reservoirs may contain a different coating composition, while in other embodiments, one or more of the reservoirs may contain the same coating composition.

In some embodiments, first reservoir 106 and second reservoir 108 may be maintained at the ambient pressure of a facility in which the reservoirs 106 and 108 are located, or may be maintained at a pressure equivalent to, greater than or less than the ambient pressure of the facility as needed to manage droplet emission from the respective one of nozzles 102 and 104. In other embodiments, reservoirs 106 and 108 may simply utilize gravity-fed fluidic principles of operation to supply first coating composition 110 and second coating composition 112, respectively, to first nozzle 102 and second nozzle 104. In yet other embodiments, a first pump may be fluidically connected between first reservoir 106 and first nozzle 102 and a second pump may be fluidically connected between second reservoir 108 and second nozzle 104.

At least one of reservoirs 106 and 108 may optionally include a structure for agitating and/or controlling the temperature or composition of the respective coating composition 110 or 112, such as, for example, an impeller, a low frequency or ultrasound radiator, fluid passageways for coolant, and the like. In some embodiments, one or more sensors may be employed to monitor the temperature or content of at least one of the reservoirs 106 and 108 and/or the coating compositions 110 and 112 and indicating via a signal whether or not the coating compositions 110 and 112 remain within desired operating conditions or parameters. If not, the signal can automatically trigger appropriate action to return the first or second coating composition 110 or 112 to the desired operating conditions or parameters.

First nozzle 102 and second nozzle 104 eject first coating composition 110 and second coating composition 112, respectively, and deposit the compositions 110 and 112 on substrate 114 in a layer 122, as illustrated in FIG. 1A. In some embodiments, substrate 114 may form a portion of a medical device, such as, for example, an inner surface of a capacitor casing, a portion of a primary (one-time use) or secondary (rechargeable) battery casing, a conductor, a current carrier, or a temporary or sacrificial substrate. Substrate 114 may include a metal, such as, for example, aluminum, tantalum, niobium, titanium, zirconium, copper, or the like. In other embodiments, substrate 114 may include glassy carbon or a metal oxide in glass or ceramic form. In yet other embodiments, substrate 114 may comprise another material that the at least one coating material in each of coating compositions 110 and 112 may adhere to, such as a polypropylene, polytetrafluoroethylene, high density polyethylene, filled or unfilled hydrogenated nitrile butadiene rubber (HNBR), or another polymer that is stable within the environment in which electrode 116 will be used.

First coating composition 110 may comprise at least a first coating material and second coating composition 112 may comprise at least a second coating material, which each provides or modifies properties of the electrode 116. For the sake of conciseness, the at least a first coating material in first coating composition 110 and the at least a second coating material in second coating composition 112 will be referred to hereafter as “first coating material” and “second coating material,” respectively. However, it will be understood that this does not limit first coating composition 110 to including a single coating material and second coating composition 112 to including a single, different, coating composition. Rather, the first and second coating compositions 110 and 112 may each comprise one, two or more coating materials, and the coating materials in first and second coating compositions 110 may be the same or different. For example, the first coating composition 110 may include a first and second coating materials, while the second coating composition 112 includes the first coating material and a third and fourth coating materials. Other combinations of coating materials in coating compositions 110 and 112 are also envisioned.

In some embodiments, the first and second reservoirs 106 and 108 may contain first and second materials, rather than first and second coating compositions 110 and 112, respectively. The first and second materials may be introduced over substrate 114 by first and second nozzles 102 and 104 in a method similar to any of those described herein with reference to first and second coating compositions 110 and 112.

The properties of the electrode 116 provided or modified by the first and second coating materials in first and second coating compositions 110 and 112, respectively, may be controlled at a plurality of locations within layer 122 by controlling the relative amounts of the coating materials deposited at the plurality of locations. For example, in some embodiments, the composition of layer 122 may be controlled in at least two of the orthogonal x-, y- and z-axes (dimensions) illustrated in FIG. 1A. In other embodiments, the composition of layer 122 may be controlled in all three orthogonal axes (dimensions). The relative amounts of the first coating material in first coating composition 110 and the second coating material in second coating composition 112 may be controlled to change substantially continuously within at least a portion of layer 122, or may be controlled to change discontinuously within layer 122, as will be described herein. The first coating material in first coating composition 110 and second coating material in second coating composition 112 may provide or modify at least one of an electrical conductivity, a thermal conductivity, a mechanical property, a power capability, an energy density, a chemical activity and an electrochemical activity of layer 122, as will be described in further detail herein.

In order to control the relative amounts of the first coating material in first coating composition 110 and the second coating material in second coating composition 112 at one or more locations within layer 122, the position at which first nozzle 102 and second nozzle 104 deposit at least one of first and second coating compositions 110 and 112, respectively, may be controlled. In some embodiments, the printing position may be controlled by adjusting the relative position of first nozzle 102 and substrate 114, and second nozzle 104 and substrate 114, respectively. In some embodiments, first nozzle 102 and second nozzle 104 may be movable in one or more dimensions. For example, first and second nozzles 102 and 104 may be attached to a stage that is movable in one, two or three dimensions. In other embodiments, substrate 114 may be coupled to a translatable stage that is movable in one or more dimensions. For example, substrate 114 may be disposed on a conveyor, a cart, a table capable or swiveling and/or moving in the x-, y-, and/or z-axes, or the like, that is either manually or automatically controlled to move past and/or about first and second nozzles 102 and 104.

In some embodiments, both substrate 114 and first and second nozzles 102 and 104 are movable relative to each other. In embodiments such as these, substrate 114 may be movable in one or two dimensions, and first and second nozzles 102 and 104 may be movable in a complimentary one or two dimensions to provide relative movement of substrate 114 and nozzles 102 and 104 in all three orthogonal dimensions. Alternatively, substrate 114 and nozzles 102 and 104 may all be movable in one or more dimensions, which may be the same or different. Control of the relative position of substrate 114 and nozzles 102 and 104 may be performed manually or automatically, such as, for example, through computer numerical control (CNC) or other control software, firmware, or hardware.

The printing position of first coating composition 110 and second coating composition 112 may also be controlled utilizing electrostatic attraction or repulsion of the coating compositions 110 and 112 to or from magnetic fields adjacent apertures 118 and 120, respectively. For example, in a drop-on-demand fluid emission printing process, the droplets of first coating composition 110 and second coating composition 112 may be electrostatically charged. By ejecting the droplets of first and second coating compositions 110 and 112 through a respective magnetic field, the trajectory of the droplets may be changed. When the electrostatic charge of each of the droplets and the velocity with which the droplets are ejected from nozzles 102 and 104 are known, the position at which the droplets impact the substrate can be controlled by changing the magnitude and/or orientation of the magnetic field. The magnetic field may be varied more quickly than substrate 114 or nozzles 102 and 104 may be moved, and so may provide quicker control of the position at which first and second coating compositions 110 and 112 are printed on substrate 114. Magnetic field control of the position of the printing of first and second coating compositions 110 and 112 may be used alone or in combination with control of the relative position of substrate 114 and nozzles 102 and 104.

In addition to controlling the position at which first and second coating compositions 110 and 112 are printed on substrate 114, the relative spray rates and printing durations of first coating composition 110 and second coating composition 112 may be controlled to providing control of the relative amounts of the first and second coating materials in first and second coating compositions 110 and 112, respectively, at the plurality of locations within layer 122. In a continuous-type fluid emission printing process, the relative printing rates of the first coating composition 110 and second coating composition 112 may be controlled by controlling a flow rate of at least one of first coating composition 110 and second coating composition 112. The flow rate of first coating composition 110 and second coating composition 112 may be controlled by, for example, controlling a pressure of the first and second reservoirs 106 and 108, respectively, by controlling a position of a valve fluidically coupled between first reservoir 106 and first nozzle 102, or a valve fluidically coupled between second reservoir 108 and second nozzle 104, or by controlling a pump fluidically connected between first reservoir 106 and first nozzle 102 or between second reservoir 108 and second nozzle 104. In some embodiments, the flow rate of both the first coating composition 110 and the second coating composition 112 may be controlled to control the relative flow rate, while in other embodiments, the flow rate of one of first coating composition 110 or second coating composition 112 may be controlled. In some embodiments, a substantially constant combined printing rate of first coating composition 110 and second coating composition 112 may be maintained, so any change in the flow rate of first coating composition 110 is accompanied by a substantially equal and opposite change in the flow rate of second coating composition 112. In other embodiments, the combined printing rate of first coating composition 110 and second coating composition 112 may not be constant.

In a drop-on-demand fluid emission printing process, the relative printing rates of first coating composition 110 and second coating composition 112 may be controlled by controlling a rate of droplet formation of at least one of first and second coating compositions 110 and 112. For example, in a piezoelectric fluid emission printing process, the rate of droplet formation may be controlled by a frequency of the voltage applied to the piezoelectric crystal. Similar to the discussion above with respect to continuous-type fluid emission printing, in some embodiments, the rate of droplet formation of each of first and second coating compositions 110 and 112 is controlled, while in other embodiments, the rate of droplet formation of one of first and second coating compositions 110 and 112 is controlled while the rate of droplet formation of the other coating composition 110 or 112 is maintained substantially constant. In some embodiments, the combined rate of droplet formation of first and second coating compositions 110 and 112 may be maintained substantially constant, so that a change in the rate of droplet formation of first coating composition 110 is accompanied by a substantially equal and opposite change in the rate of droplet formation of second coating composition 112. In other embodiments, the combined rate of droplet formation of first coating composition 110 and second coating composition 112 may not be constant.

In some embodiments, control of the relative amounts of the first coating material in first coating composition 110 and the second coating material in second coating composition 112 may include not printing at least one of first and second compositions 110 and 112 at one or more location of substrate 114.

In some embodiments, control of the relative amounts of the first and second coating materials in coating compositions 110 and 112, respectively, and thus control of the properties of layer 122 may be accomplished by controlling the composition of at least one of first coating composition 110 and second coating composition 112. For example, as described briefly above, each of first coating composition 110 and second coating composition 112 may include a fluid carrier or a fluid solvent that carries in suspension or dissolves the first and second coating materials, respectively. Accordingly, by changing a concentration of the first coating material in first coating composition 110, the effective printing rate of the first coating material may be changed while maintaining the printing rate first coating composition 110. Similarly, by changing a concentration of the second coating material in second coating composition 112, the effective printing rate of the second coating material may be changed while maintaining the printing rate of second coating composition 112. Compositional control of the first coating material in first coating composition 110 and/or the second coating material in second coating composition 112 may be utilized alone or in combination with control of the relative printing rates of the first coating composition 110 and second coating composition 112.

In combination with controlling the relative printing rate of the first and second materials, the time for which the first and second materials are printed at each of the plurality of locations may be controlled. For example, printing the first composition 110 with a constant flow rate and composition for a shorter amount of time at a location will result in a smaller amount of the first material being deposited than printing the first composition 110 for a longer period of time.

As illustrated in FIG. 1, first nozzle 102 and second nozzle 104 may eject first coating composition 110 and second coating composition 112, respectively, in fan-shaped sprays 124 and 126. Fan-shaped sprays 124 and 126 may be formed of a plurality of droplets of coating compositions 110 and 112, respectively. The plurality of droplets may be formed by continuous-type or drop-on-demand ink jet printing processes. Fan-shaped sprays 124 and 126 are illustrated as substantially one-dimensional (i.e., extending along a line) in the plane of substrate 114. In other embodiments, fan-shaped sprays 124 and 126 may include a cone shape, which results in a circle in the plane of substrate 114. Additionally, while fan-shaped sprays 124 and 126 are illustrated as extending substantially the entire width of substrate 114, sprays 124 and 126 may, in other embodiments, extend less than the entire width of substrate 114. The shape and/or width of first fan-shaped spray 124 may also be different from the shape and/or width of second fan-shaped spray 126. In some embodiments, the shape and/or width of at least one of fan-shaped sprays 124 and 126 may also be adjusted during the printing process. For example, the width of first fan-shaped spray 124 may initially be relatively large to quickly coat a first portion of substrate 114, and may then be decreased to print finer features on a second portion of substrate 114, which may be the same or different from the first portion of substrate 114.

While FIG. 1 illustrates first fan-shaped spray 124 and second fan-shaped spray 126 being directed to substrate 114 at substantially the same location, in other embodiments, first and second fan-shaped sprays 124 and 126 may be directed to different locations on substrate 114. Additionally, in other embodiments, first fan-shaped spray 124 and second fan-shaped spray 126 may mix prior to coating compositions 110 and 112 being deposited on substrate 114. For example, first and second fan-shaped sprays 124 and 126 may be mixed at a location between first and second nozzles 102 and 104 and substrate 114.

In some embodiments, the first coating material in first coating composition 110 may include silver vanadium oxide (Ag₂V₄O₁₁; SVO) and the second coating material in second coating composition 112 may include carbon fluoride (CFₓ). As used herein, carbon fluoride refers to methane with 1-4 substituent fluorine atoms; that is, fluoromethane (CH₃F), difluoromethane (CH₂F₂), trifluoromethane (CHF₃) or tetrafluoromethane (CF₄).

In further embodiments, at least one of the first and second coating materials may include a carbon material. The carbon material may include any form of carbon, including, for example, graphite, a polymorph of the element carbon, as well as relatively pure forms of carbon black (also known as carbon soot, lamp black, channel black, furnace black, acetylene black, thermal black, or the like), such as, for example, an acetylene black available under the tradename Shawinigan Black® from Chevron Phillips, The Woodlands, Tex. Alone or in combination with one or more of the foregoing forms of carbon black, carbon nanotube material may be used. Such nanotube material may include either single-wall nanotubes (SWNT) or multi-wall nanotubes (MWNT). The carbon, whether in pure form, nanotube form, or otherwise, can be impregnated with or carried in a fluid vehicle or solution. The solutions may include any material that will be driven off during annealing, such as, for example, volatile organic solvents and certain polymeric materials.

The present disclosure is not limited to the coating materials discussed above. Rather, virtually any kind of material, which can be processed as a suspension or solution and which is suitable as a coating material for an electrode, may be used within the scope of this disclosure as long as its fluidic characteristics such as, for example, viscosity, surface tension, solids, content, and the like, are matched to the droplet or mist ejection characteristics of first and/or second nozzles 102 and 104. Other coating materials suitable for being printed onto substrate 114 in the form of a solution or suspension include oxides of any metal included in one or more of Group VII and Group VIII of the periodic table or chemical precursors for such oxides, e.g., chlorides or nitrides. For example, the metal oxides may include ruthenium dioxide (RuO₂), together with the oxide precursor RuCl₃, iridium dioxide (IrO₂), manganese dioxide (MnO₂) together with the oxide precursor manganese nitride (Mn(NO₃)₂), vanadium pentoxide (V₂O₅), titanium dioxide (TiO₂), rhenium dioxide (ReO₂), osmium dioxide (OsO₂), molybdenum dioxide (MoO₂), rhodium dioxide (RhO₂), vanadium dioxide (VO₂), and tungsten dioxide WO₂). The metal oxide may include on or more of these types of oxides and/or may include other metal oxides comprising metals in at least one of Group VII and Group VIII of the periodic table.

Other suitable first and/or second coating materials may include electrode materials such as, for example, LiCoO₂, LiM₂O₄ (where M is a transition metal), Li MₓCO₁₋ₓO₂ (where M is a transition metal and x is in a positive number greater than zero and less than one), LiFePO₄, Li(MnNiCo)_{1/3}O₂, and the like, which may be used for a positive electrode. First and/or second coating materials may also include electrode materials such as, for example, carbon (graphite, hard carbon, mesophase) alloys with Sn, Sb, Si, Sn₃₀C₃₀CO₄₀, Li₄Ti₅O₁₂, or other transition metal transition metal oxides, which may be used for a negative electrode. Other suitable electrode materials are described in U.S. Published Patent Application Nos. 2006/0095094, 2006/0093923, 2006/0093917, 2006/0093913, and 2006/0093872, the entire contents of which are incorporated herein by reference in their entirety.

The first and second coating materials in first coating composition 110 and second coating composition 112, respectively, may be suspended in a fluid vehicle, such as, for example, a solvent or suspension carrier, which is formulated to maintain a desired combination of surface tension, viscosity, or density, as is known in the chemical and industrial coating art. In some examples, the solvent or suspension carrier may include a volatile solvent or polymer melt. In some embodiments, the fluid vehicle may include a glycol, distilled water, alcohol or the like.

While the embodiment illustrated in FIG. 1 has been described as including a single layer 122 on substrate 114, in other embodiments, system 100 may print a plurality of layers on substrate 114. In some embodiments, each of the layers may provide different properties to the electrode, such as, for example, an inner layer with high charge density, a middle layer with high electrical conductivity, and an outer layer with high power capability. In other embodiments, the electrode 116 may include an outer layer which serves as a durability coating that increases the mechanical durability of the electrode 116. The plurality of layers may also include, for example, a layer with greater heat transfer properties.

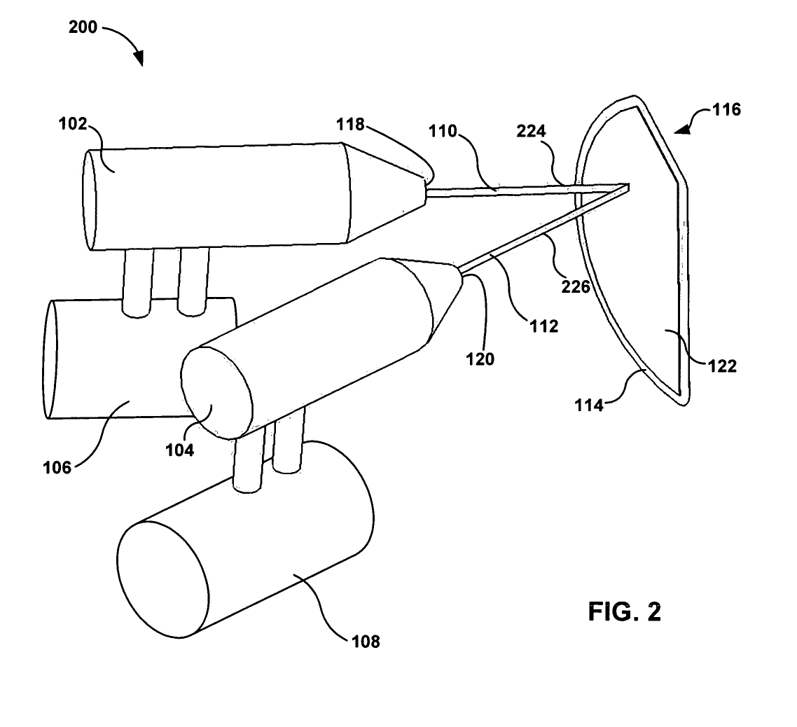

FIG. 2 is a conceptual line diagram of another example system 200 for printing a layer 122 of an electrode 116 on a substrate 114. System 200 includes a first nozzle 102 and a second nozzle 104. Similar to system 100 described above with respect to FIG. 1, system 200 of FIG. 2 may include three or more nozzles in other embodiments. In the embodiment illustrated in FIG. 2, first nozzle 102 is fluidically coupled to a first reservoir 106, which contains a first coating composition 110. Similarly, second nozzle 104 is fluidically coupled to a second reservoir 108, which contains a second coating composition 112.

In the embodiment illustrated in FIG. 2, first coating composition 110 and second coating composition 112 are ejected from first nozzle 102 and second nozzle 104, respectively, in a relatively concentrated first beam 224 and a relatively concentrated second beam 226. First beam 224 and second beam 226 may allow more precise control of the location at which first coating composition 110 and second coating composition 112 are deposited compared to first fan-shaped spray 124 and second fan-shaped spray 126 illustrated in FIG. 1. For example, first beam 224 and second beam 226 may include a stream of sequential single droplets of first coating composition 110 and second coating composition 112, respectively, formed by a drop-on-demand fluid emission printing process or continuous fluid emission printing process. First beam 224 and second beam 226 may facilitate finer control of the location at which first coating composition 110 and/or second coating composition 112 are printed on substrate 114. As a result, the system 200 may provide finer positional control of the relative amount of the first coating material in first coating composition 110 and the second coating material in second coating composition 112, and ultimately, the properties of the layer 122 compared to system 100 of FIG. 1.

While FIG. 2 illustrates first beam 224 and second beam 226 converging to a single location within layer 122, in other embodiments, first beam 224 and second beam 226 may be directed at different locations and may not converge to a single location. As described above with respect to FIG. 1, first beam 224 and second beam 226 may also be mixed prior to first coating composition 110 and second coating composition 112 being deposited on substrate 114.

Similar to the embodiment illustrated in FIG. 1, the position at which first coating composition 110 and second coating composition 112 are printed on substrate 114 or within layer 122 may be controlled by adjusting the relative position of first nozzle 102 and substrate 114, and second nozzle 104 and substrate 114, respectively. In embodiments in which first coating composition 110 and second coating composition 112 are printed on substrate 114 as electrostatically charged droplets, the printing position may also be controlled by a controllable magnetic field adjacent nozzles 118 and 120. The electrostatic position control may be utilized alone or in conjunction with controlling the relative position of first nozzle 102 and substrate 114, and the second nozzle 104 and substrate 114.

Also similar to the embodiment illustrated in FIG. 1, the relative amount of the first coating material in first coating composition 110 and the second coating material in second coating composition 112 may be controlled at a plurality of locations within layer 122 by controlling the relative printing rates, the composition, or both of at least one of first and second coating compositions 110 and 112.

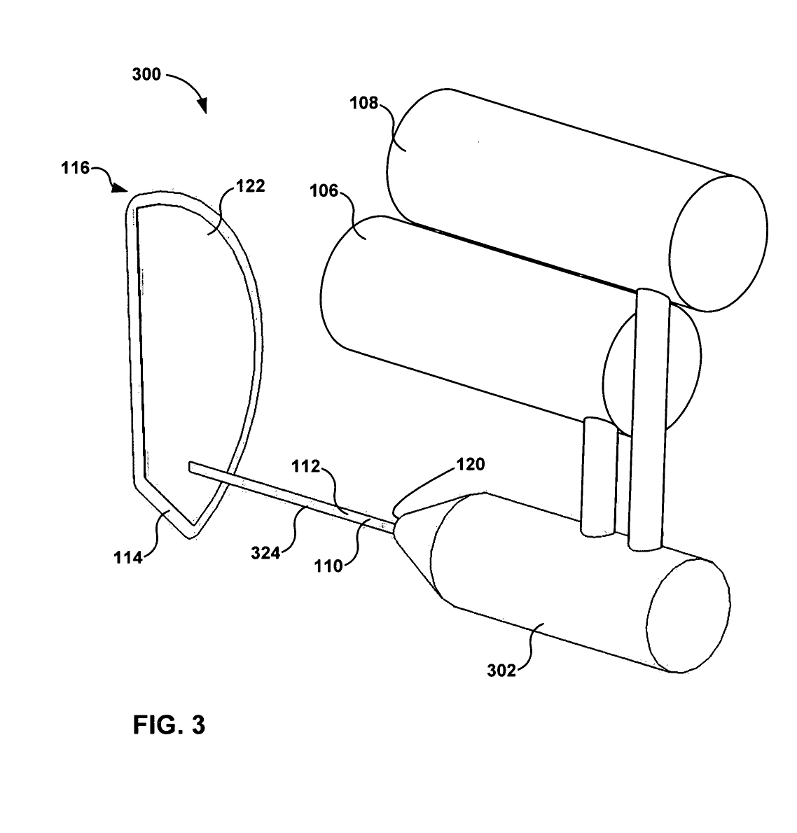

FIG. 3 illustrates a conceptual line diagram of another system 300 that may be used to print a layer 122 of an electrode 116 on a substrate 114. System 300 of FIG. 3 includes a single nozzle 302, which is fluidically coupled to a first reservoir 106 and a second reservoir 108. First reservoir 106 contains a first coating composition 110, while the second reservoir 108 contains a second coating composition 112. Nozzle 302 ejects from aperture 120 a stream 324 that may include both first coating composition 110 and second coating composition 112.

Because first coating composition 110 and second coating composition 112 are combined in nozzle 302 prior to ejection from aperture 120, mixing of first coating composition 110 and second coating composition 112 may be improved compared to system 100 or system 200, in which the coating compositions 110 and 112 are ejected in two separate fan-shaped sprays 124 and 126 or two separate streams 224 and 226. Improved mixing of first coating composition 110 and second coating composition 112 may improve, for example, homogeneity of areas of layer 122 that comprise a substantially similar relative amount of the first coating material in first coating composition 110 and the second coating material in second coating composition 112.

Control of the relative amount of the first coating material in first coating composition 110 and second one coating material in second coating composition 112, and thus properties, of layer 122 in system 300 may be accomplished by controlling a supply of at least one of first coating composition 110 and second coating composition 112 to the ink 302, or by controlling a composition of at least one of first coating composition 110 and second coating composition 112. In some embodiments, the supply of both the first coating composition 110 and the second coating composition 112 to nozzle 302 may be controlled, while in other embodiments, the supply of first coating composition 110 is substantially constant, while the supply of the second coating composition 112 is controlled. In yet other embodiments, a ratio of the first coating composition 110 to the second coating composition 112 may be controlled while the total amount of coating compositions 110 and 112 ejected out of aperture 120 is approximately constant. In some embodiments, at least one of the first coating composition 110 and second coating composition 112 may not be supplied to nozzle 302 at some time(s) during the coating process, so that a portion of layer 122 containing only the first coating material in first coating composition 110 or only the second coating material in second coating composition 112 is formed on substrate 114.

As described above, the relative position of substrate 114 and nozzle 302 may be controlled to control a position at which the first coating composition 110 and the second coating composition 112 are deposited. Additionally, electrostatically charged coating compositions 110 and 112 may be utilized in conjunction with a magnetic field adjacent aperture 120 to control the position at which at least one of first and second coating compositions 110 and 112 are deposited. In some embodiments, the relative position of substrate 114 and nozzle 302 is controlled in combination with utilizing electrostatically charged first and second coating composition 110 and 112 and a magnetic fields adjacent aperture 120.

The coating systems described herein may be used to control at least one property of layer 122 at a plurality of locations within layer 122 by controlling the relative amount of the first coating material in first coating composition 110 and the second coating material in second coating composition 112 at the plurality of locations within the layer 122. As described briefly above, the properties of the layer 122 that may be controlled include, for example, electrical properties, thermal conductivity, mechanical properties, chemical properties and biological properties. While the following properties are discussed individually, it will be understood that combinations of one or more of these properties may be controlled in layer 122 by appropriately controlling the relative amount of the first coating material and the second coating material at the plurality of locations within the layer 122

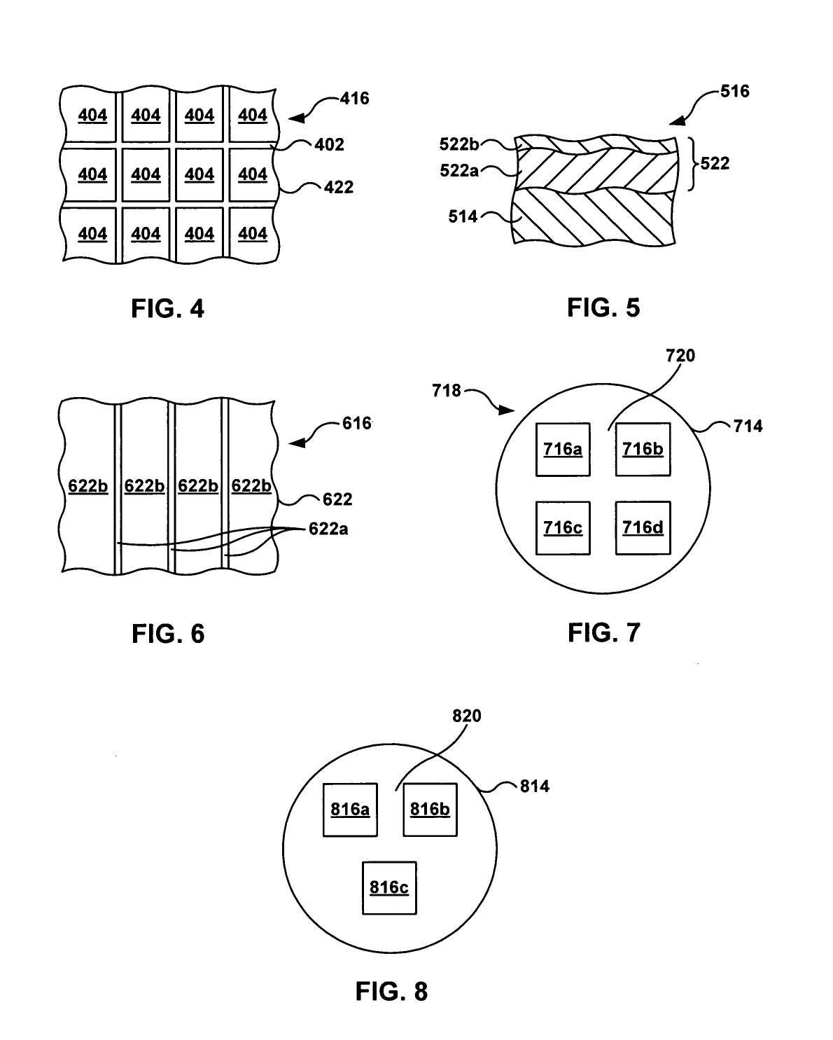

The electrical properties of the electrode 116 modified by the first and second coating materials in first and second coating compositions 110 and 112, respectively may include, for example, electrical conductivity, power capability and energy density. For example, as illustrated in FIG. 4, the relative amount of the first and second coating materials may be controlled such that a more conductive composition forms a grid 402 within a less conductive composition 404. This may be desired in embodiments in which layer 422 forms a layer of an electrode 416 used in a capacitor electrode or battery electrode, to provide current collection and routing to the terminals of the battery or an electrical feedthrough from the capacitor to an externals conductor. The electrode 416 including a more conductive grid 402 within a less conductive composition 404 may eliminate the need for a conventional current collector, and may thus reduce the thickness of the electrode 416.

In other embodiments, the conductivity of electrode 416 may be controlled to direct current around or away from portions of the electrode 416 which are adjacent temperature sensitive components, such as circuitry in an implantable medical device, so that any temperature increase due to heat generated by current flowing in the electrode is more distant from the temperature sensitive components. Further, in some embodiments, the conductivity of the layer 122 may be controlled in other geometrical configurations, may not be periodic, or may vary in another manner. Additionally, in some embodiments, the conductivity of layer 422 may not vary discontinuously as illustrated in FIG. 4, but may instead vary substantially continuously within layer 422. In embodiments in which the conductivity of layer 422 varies substantially continuously, the conductivity may still be controlled to provide more highly conductive pathways in a less conductive composition 404 to direct current to an electrical feedthrough or terminal, or to direct current away from heat-sensitive components, as described above.

As illustrated in FIG. 5, the power capability and energy density of electrode 516 may be controlled by controlling the composition of layer 522 at each of a plurality of locations. In general, the power capability of electrode 516 is determined by the composition of electrode 516 at its surface, while the energy density of electrode 516 is determined by its average composition. Thus, by forming layer 522 with a composition that includes a greater amount of a component with a high power capability at the surface of electrode 516 and a greater amount of a component with a high energy density throughout the remainder of layer 522, a hybrid electrode 516 with both a relatively high power capability and relatively high energy density may be formed. For example, when the first coating material in the first coating composition 110 comprises silver vanadium oxide (SVO) and the second coating material in second coating composition 112 comprises carbon fluoride (CFx), an interior portion 522a of the layer 522, which is adjacent substrate 514 may include a higher concentration of CFx, while an exterior portion 522b of layer 522 may include a higher concentration of SVO. Interior portion 522a, which includes a higher concentration of CFx, provides a higher energy density than a layer 522 formed of only SVO, while the exterior portion 522b, which includes a higher concentration of SVO, provides a greater power capability than a layer 522 formed of only CFx. While FIG. 5 illustrates a layer 522 including interior portion 522a and exterior portion 522b, in some embodiments layer 522 may not include a distinct interior portion 522a and a distinct exterior portion 522b, but may instead include a relative amount of the first coating material and the second coating material that varies substantially continuously in at least a portion of layer 722 in a direction substantially normal to the plane of substrate 514.

FIG. 5 also illustrates layer 522 printed on a substrate 514 that is non-planar. Printing of layer 522 enables the formation of a layer 522 with substantially controlled thickness, even on a non-planar substrate 514. In some embodiments, such as the embodiment illustrated in FIG. 5, the thickness of layer 522 may be controlled to be substantially uniform on the non-planar substrate 514. In other embodiments, the thickness of layer 522 may be controlled to produce a non-uniform thickness profile on a substrate 522 that is either planar or non-planar.

The mechanical properties of the electrode 116 modified by the first coating material in first coating composition 110 and the second coating material in second coating composition 112 may include, for example, stiffness or durability. The stiffness of the electrode 116 may be controlled by controlling a thickness of the layer 122, including not printing at least one of the first and second coating compositions 110 and 112 at a location of substrate 114, or by controlling the relative amount of the first coating material and the second coating material at a plurality of locations within the layer. For example, simply controlling the thickness of the layer 122 may change the stiffness of the electrode 116. A thinner portion of layer 122 may result in a more flexible portion of electrode 116 than a portion of electrode 116 having a thicker layer 122.

In some embodiments the first coating material may be more flexible than the second coating material. For example, CFx may be more flexible and less brittle than SVO. Accordingly, as illustrated in FIG. 6, printing first portions 622a of layer 622 of electrode 616 with a higher relative amount of CFx compared to second portions 622b of layer 622 having a higher relative amount of SVO. This may result in electrode 616 preferentially deforming or bending at first portions 622a, which may be beneficial for an electrode 616 that is to undergo further processing to result in a non-planar shape, such as a ridged shape, a spiral shape, or the like. In some embodiments, the first portions 622a, which include the higher relative amount of CFx or another relatively flexible first coating material may comprise solely CFx, while in other embodiments the first portions 622a may comprise CFx and SVO, but a higher relative amount of CFx than second portions 622b. The flexibility of the layer 622 may be controlled in at least two dimensions (e.g., in the plane of the electrode 616)

The durability of the layer 122 may also be controlled by controlling the relative amount of the first coating material in the first coating composition 110 and the second coating material in the second coating composition 112 in each of a plurality of locations within layer 122. For example, the first coating material may comprise a coating material with relatively high mechanical durability. The relative amount of the first coating material may be controlled to be relatively greater adjacent an outer surface of the layer 122 to essentially provide a protective coating in layer 122 while minimizing any effects on the remainder of layer 122. In one embodiment, at least one of the first and second coating materials may include carbon and may be printed on a substrate 114 including titanium. The substrate 114 and layer 122 may then be heated to react the carbon and titanium to form titanium carbide, which may be highly durable.

The chemical properties of the electrode 116 modified by the first coating material in the first coating composition 110 and the second coating material in the second coating composition 112 may include a chemical activity or the like. For example, the relative amount of the first and second coating materials may be controlled to provide responsiveness to a certain chemical species, such as, for example, glucose for a glucose sensor electrode, hydrogen ions for a pH sensor electrode, or the like. In some embodiments, as illustrated in FIG. 7, a plurality of electrodes 716a, 716b, 716c, 716d (collectively “electrodes 716”) may be printed on a substrate 714 in an electrode array 718. In some embodiments, a first one of the electrodes 716 may comprise a relative amount of the first and second coating materials that result in a different chemical activity than a second one of the electrodes 716. In some embodiments, each of the electrodes 716 comprises a different relative amount of the first and second coating materials such that each of electrodes 716 has a different chemical activity.

In some embodiments, each of the electrodes 716 in the electrode array 718 may be electrically insulated from the other electrodes 716 by an electrically insulating area 720. The electrically insulating area 720 may also be printed on substrate 714, and may be a third coating material in a third coating composition, which is printed from a third nozzle. In other embodiments, each of the electrodes 716 may be printed on a substrate 714 that is substantially non-conductive, and the electrode array may not include a printed electrically insulating area 720.

In other embodiments, an electrode may be a segmented electrode 816, which includes a plurality of electrode portions 816a, 816b, 816c. The electrode portions 816a, 816b, 816c may be electrically coupled to the same sensor or stimulation generator. In some embodiments, each of the electrode portions 816a, 816b, 816c is formed of a different relative amount of the first and second coating materials, while in other embodiments, at least two of the electrode portions 816a, 816b, 816c are formed of a substantially similar relative amount of the first and second coating materials. In some embodiments, each of the electrodes portions 816a, 816b, 816c may be electrically insulated from the other electrode portions 816a, 816b, 816c by an electrically insulating area 820. The electrically insulating area 820 may also be printed on substrate 814, and may be a third coating material in a third coating composition, which is printed from a third nozzle. In other embodiments, each of the electrode portions 816a, 816b, 816c may be printed on a substrate 814 that is substantially non-conductive, and the electrode array may not include a printed electrically insulating area 820.

The thermal properties of electrode 116 may include thermal conductivity. The thermal conductivity of layer 122 may be controlled in at least two dimensions by controlling the relative amount of the first coating material and second coating material at a plurality of locations within layer 122. The thermal conductivity of layer 122 may be varied to, for example, provide more highly conductive thermal pathways to effectively transfer heat from layer 122 and electrode 116. In some embodiments, controlling the thermal conductivity of layer 122 may be performed in conjunction with controlling a conductivity of layer 122 to provide further protection of heat-sensitive components from heat generated due to electric current conduction in layer 122, for example. In some embodiments, the thermal conductivity of layer 122 may vary substantially continuously in at least a portion of layer 112, and in some embodiments, the thermal conductivity of layer 122 may vary discontinuously in at least a portion of layer 122.

In yet other embodiments first coating composition 110 or second coating composition 112 may include at least one coating material and a sacrificial component that are together used to produce a porous layer 122 on substrate 114. The porous layer may increase electrolyte access to the interior of electrode 116 when used in an electrolytic capacitor or a battery including an electrolyte. For example, the sacrificial component may include a chemical species that is removed by a subsequent heat treatment step to form voids in a matrix of a material that is not consumed in the heat treatment step. In some embodiments, the sacrificial component may comprise, for example, paraffin, dimethyl sulfone, stearic acid, ammonium bicarbonate, or a polymer such as, for example, polytetrafluoroethylene (PTFE). The sacrificial component may be removed from the layer 122 by dissolving, sintering, burning, evaporation, vacuum evaporation, or the like.

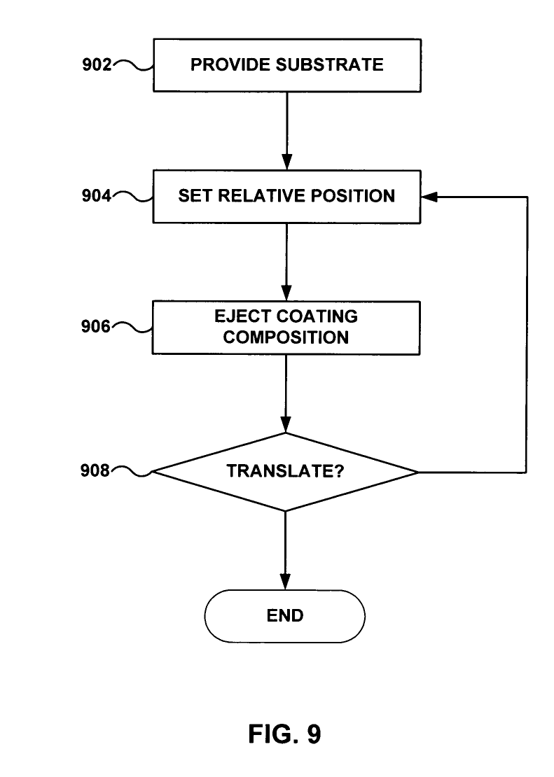

FIG. 9 illustrates an example method 900 of printing a layer 122 of an electrode 116 on a substrate 114, which will be discussed with further reference to FIG. 1, but may also be practiced using system 200 of FIG. 2 or system 300 of FIG. 3. First, a substrate 114 is provided on which layer 122 will be printed (902). As discussed above in further detail, substrate 114 may comprise a portion of a capacitor housing, a portion of a battery housing, a conductor, a current collector, a sacrificial substrate that is destroyed after the printing process, or a plastic substrate. The relative position between substrate 114 and first nozzle 102 and second nozzle 104 is then set (904). The relative position may be set by moving substrate 114 in at least one dimension, moving first nozzle 102 and/or second nozzle 104 in at least one dimension, or moving substrate 114 and first nozzle 102 and/or second nozzle 104 in at least one dimension. In some embodiments, the position of first nozzle 102 and second nozzle 104 may be independently controlled, while in other embodiments, first and second nozzle 102 and 104 are coupled to a common moveable stage, and the positions of first and second nozzles 102 and 104 relative to substrate 114 may not be controlled independently. As discussed above, the relative positions of substrate 114 and first and second nozzles 102 and 104 may be controlled manually or automatically, such as, for example, using a CNC machine.

Once the relative positions of substrate 114 and first and second nozzles 102 are set, at least one of the first coating composition 110 and second coating composition 112 are ejected from first nozzle 102 and second nozzle 104, respectively, and printed on substrate 114 (906). The user, in manual control, or processor, in CNC or other software, hardware or firmware control, then determines whether the relative positions of substrate 114 and first and second nozzles 102 and 104 are to be translated (908). When the relative positions are to be translated, the user or processor sets the new relative positions (904) and ejects at least one of the first coating composition 110 and second coating composition 112 (906). When the processor determines that the relative positions are not to be translated, the method ends.

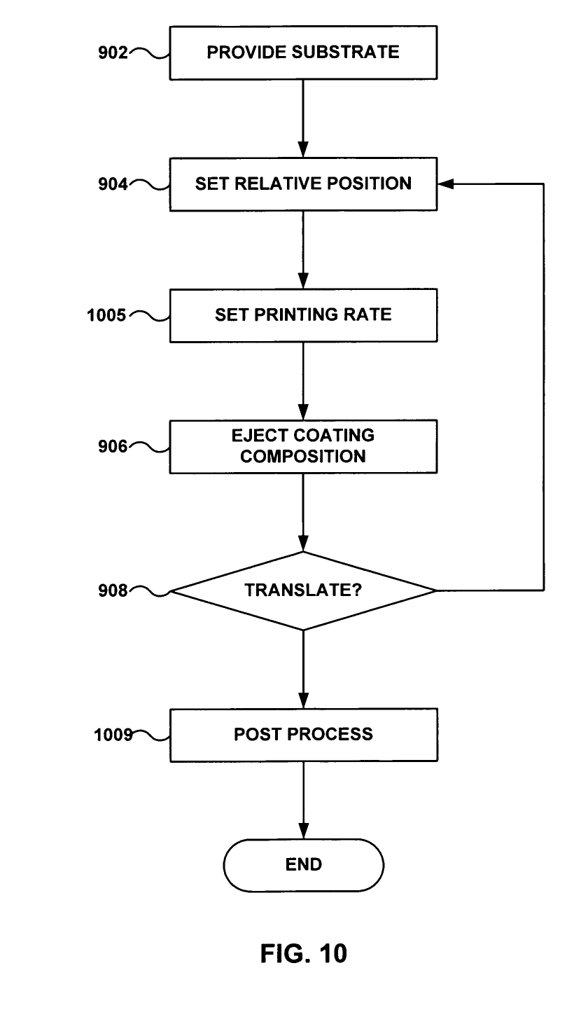

FIG. 10 is a flow diagram of another example method by which a layer 122 of an electrode 116 may be printed on a substrate 114, which will be discussed with further reference to FIG. 1, but may also be practiced using system 200 of FIG. 2 or system 300 of FIG. 3. First, a substrate 114 is provided on which layer 122 will be printed (902). As discussed above in further detail, substrate 114 may comprise a portion of a capacitor housing, a portion of a battery housing, a conductor, a current collector, a sacrificial substrate that is destroyed after the printing process, or a plastic substrate. The relative position between substrate 114 and first nozzle 102 and second nozzle 104 is then set (904). The relative position may be set by moving substrate 114 in at least one dimension, moving first nozzle 102 and/or second nozzle 104 in at least one dimension, or moving substrate 114 and first nozzle 102 and/or second nozzle 104 in at least one dimension. In some embodiments, the position of first nozzle 102 and second nozzle 104 may be independently controlled, while in other embodiments, first and second nozzle 102 and 104 are coupled to a common moveable stage, and the positions of first and second nozzles 102 and 104 relative to substrate 114 may not be controlled independently. As discussed above, the relative positions of substrate 114 and first and second nozzles 102 and 104 may be controlled manually or automatically, such as, for example, using a CNC machine.

Once the relative positions of substrate 114 and first and second nozzles 102 are set, the relative printing rate of the first material and the second material is set (1005). As discussed above in further detail, the relative printing rate of the first material and the second material may be controlled by controlling the composition of at least one of first coating composition 110 and second coating composition 112, controlling the flow rate or drop formation rate of at least one of first coating composition 110 and second coating composition, or combinations thereof. Once the relative printing rate of the first material and the second material is set, at least one of the first coating composition 110 and second coating composition 112 is ejected from the first nozzle 102 or second nozzle 104, respectively, and printed on substrate 114 (906). Similar to FIG. 9, the user or processor then determines whether the relative positions of substrate 114 and first and second nozzles 102 and 104 are to be translated (908). When the relative positions of substrate 114 and first and second nozzles 102 and 104 are to be translated, the user or processor sets the new relative positions (904).

When the relative positions of substrate 114 and first and second nozzles 102 and 104 are not to be translated, the printing process ends, and the electrode 116 including layer 122 may proceed to a post-processing step (1009). For example, in some embodiments, the electrode 116 including layer 122 may undergo to a heat treatment step to remove the fluid carrier or solvent. In some embodiments, the electrode 116 including layer 122 may undergo a post-processing step to remove a sacrificial component from within layer 122 to form a porous layer 122, or may undergo a post-processing step to remove a sacrificial substrate 114. The post-processing step may also include heat treatment to anneal the first and second coating materials.

The techniques described in this disclosure may be implemented, at least in part, in hardware software, firmware or any combination thereof. For example, various aspects of the techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry.

Such hardware, software, or firmware may be implemented within the same device or within separate devices to support the various operations and functions described in this disclosure. In addition, any of the described units, modules, or components may be implemented together or separately as discrete but interoperable logic devices.

When implemented in software, the functionality ascribed to the systems, devices and techniques described in this disclosure may be embodied as instructions on a computer-readable medium such as random access memory (RAM), read-only memory (ROM), non-volatile random access memory (NVRAM), electrically erasable programmable read-only memory (EEPROM), FLASH memory, magnetic data storage media, optical data storage media, or the like. The instructions may be executed to support or control one or more aspects of the functionality described in this disclosure.

For example, instructions stored on a computer-readable medium may control a processor to control a system to introduce a first material and a second material over a substrate to form a layer of an electrode, and control at least one of an electrical conductivity, a thermal conductivity, a mechanical property, a power capability, an energy density, a chemical activity and an electrochemical activity of the layer by controlling a relative amount of the first material and the second material at each of a plurality of locations within the layer.

### EXAMPLES

### Example 1

Silver Vanadium Oxide (SVO) is prepared as described in U.S. Pat. No. 5,221,453 to Crespi, which is incorporated herein by reference in its entirety. After synthesis the SVO particle distribution is described in Table 1. The SVO is then milled to yield the composition in Table 2.

TABLE 1

| | D10 | D50 | D90 | D100 |
|---|---|---|---|---|
| | (microns) | (microns) | (microns) | (microns) |
| Non-milled | 10 | 65 | 175 | — |
| SVO | | | | |

TABLE 2

| | D10 | D50 | D90 | D100 |
|---|---|---|---|---|
| | (microns) | (microns) | (microns) | (microns) |
| Milled SVO | 1.1 | 2.4 | 4.6 | <9 |

A water-based slurry is then prepared with 40% solids of a dry weight formulation of 92% milled SVO, 6% battery grade carbon black, 1.33% styrene butadiene rubber binder (available from Zeon Corporation, Specialty Materials Division, Tokyo, Japan), and 0.67% carboxy methyl cellulose (available from Daicel Chemical Industries, Osaka, Japan).

A similar water-based slurry including carbon monofluoride is prepared, containing about 40% solids of a dry weight formulation of 92% milled carbon monofluoride, 6% battery grade carbon black, 1.33% styrene butadiene rubber binder (available from Zeon Corporation, Specialty Materials Division, Tokyo, Japan), and 0.67% carboxy methyl cellulose (available from Daicel Chemical Industries, Osaka, Japan).

The two slurries are used as liquid feeds for an ultra-spray head with integrated fluid delivery system (IFDS). The IFDS includes an ultrasonic transducer with a spray forming tip, an ultrasonic generator, an external liquid applicator, a precision liquid delivery system and air directors. Such a system is available from Ultrasonic Systems, Inc. of Haverhill, Mass. The coating slurries are stored in independent pressurized reservoirs, and fed to the liquid applicator with a precision liquid delivery system which can control their delivery rates independently. A multi-axis motion and positioning system is used to control the IFDS as demanded by the dimensions of the substrate and desired compositional patter, which may involve varied deposit thickness and/or compositional patterns that vary in two or three dimensions.

After deposition of the coating, the electrode is placed in a 55° C. vacuum oven at a pressure of about 1.33 kilopascals (kPa) to about 13.3 kPa until dry.

### Example 2

Silver Vanadium Oxide (SVO) is prepared as described in U.S. Pat. No. 5,221,453 to Crespi. After synthesis the SVO particle distribution is described in Table 3. The SVO is then milled to yield the composition in Table 4.

TABLE 3

| | D10 | D50 | D90 | D100 |
|---|---|---|---|---|
| | (microns) | (microns) | (microns) | (microns) |
| Non-milled | 10 | 65 | 175 | — |
| SVO | | | | |

TABLE 4

| | D10 | D50 | D90 | D100 |
|---|---|---|---|---|
| | (microns) | (microns) | (microns) | (microns) |
| Milled SVO | 1.1 | 2.4 | 4.6 | <9 |

A water-based slurry is then prepared with 40% solids of a dry weight formulation of 92% milled SVO, 6% battery grade carbon black, 1.33% styrene n-butadiene rubber binder (available from Zeon Corporation, Specialty Materials Division, Tokyo, Japan), and 0.67% carboxy methyl cellulose (available from Daicel Chemical Industries, Osaka, Japan).

A similar water-based slurry including carbon monofluoride is prepared, replacing SVO with carbon monofluoride containing about 40% solids of a dry weight formulation of 92% milled carbon monofluoride, 6% battery grade carbon black, 1.33% styrene butadiene rubber binder (available from Zeon Corporation, Specialty Materials Division, Tokyo, Japan), and 0.67% carboxy methyl cellulose (available from Daicel Chemical Industries, Osaka, Japan).

The two slurries are used as liquid feeds for two independent ultra-spray heads with integrated fluid delivery system (IFDS). The coating slurries are stored in independent pressurized reservoirs, and fed to the liquid applicators associated with the two precision liquid delivery systems which can each control their delivery rates independently. A multi-axis motion and positioning system is used to control the two IFDSs (mounted in fixed relation such that their sprays impinge when striking the target or substrate) as demanded by the dimensions of the substrate and desired compositional pattern, which may involve varied deposit thickness and/or compositional patterns that may vary in two or three dimensions.

After coating deposition, the electrode is placed in a 55° C. vacuum oven at a pressure of about 1.33 kilopascals (kPa) to about 13.3 kPa until dry.

### Example 3

Silver Vanadium Oxide (SVO) is prepared as described in U.S. Pat. No. 5,221,453 to Crespi. After synthesis the SVO particle distribution is described in Table 5. The SVO is then milled to yield the composition in Table 6.

TABLE 5

| | D10 | D50 | D90 | D100 |
|---|---|---|---|---|
| | (microns) | (microns) | (microns) | (microns) |
| Non-milled | 10 | 65 | 175 | — |
| SVO | | | | |

TABLE 6

| | D10 | D50 | D90 | D100 |
|---|---|---|---|---|
| | (microns) | (microns) | (microns) | (microns) |
| Milled SVO | 1.1 | 2.4 | 4.6 | <9 |

A water-based slurry is then prepared with 40% solids of a dry weight formulation of 92% milled SVO, 6% battery grade carbon black, 1.33% styrene n-butadiene rubber binder (available from Zeon Corporation, Specialty Materials Division, Tokyo, Japan), and 0.67% carboxy methyl cellulose (available from Daicel Chemical Industries, Osaka, Japan).

A similar water-based slurry including carbon monofluoride is prepared, containing about 40% solids of a dry weight formulation of 92% milled carbon monofluoride, 6% battery grade carbon black, 1.33% styrene butadiene rubber binder (available from Zeon Corporation, Specialty Materials Division, Tokyo, Japan), and 0.67% carboxy methyl cellulose (available from Daicel Chemical Industries, Osaka, Japan).

The two slurries are used as liquid feeds for two independent ultra-spray heads with integrated fluid delivery system (IFDS). The coating slurries are stored in independent pressurized reservoirs, and fed to the liquid applicators associated with the two precision liquid delivery systems which can each control their delivery rates independently. Multi-axis motion and positioning systems are used to control the independent IFDSs as demanded by the dimensions of the substrate and desired compositional pattern. The desired compositional pattern may involve varied deposit thickness and/or compositional patterns that may vary in two or three dimensions.

After the coating deposition process has been performed, the electrode is placed in a 55° C. vacuum oven at a pressure of about 1.33 kilopascals (kPa) to about 13.3 kPa until dry.

Various embodiments of the invention have been described. These and other embodiments are within the scope of the following claims.

1. A method comprising;
printing a layer of an electrode on a substrate, wherein printing the layer comprises:
ejecting a first coating composition and a second coating composition from a nozzle, wherein the first coating composition comprises at least a first coating material and the second coating composition comprises at least a second coating material, and wherein the first coating composition and the second coating composition are deposited on the substrate; and
controlling at least one of an electrical conductivity, a thermal conductivity, a mechanical property, a power capability, an energy density, a chemical activity and an electrochemical activity at each of a plurality of locations within the layer by controlling a relative amount of the first coating material and the second coating material deposited at each of the plurality of locations within the layer.

2. The method of claim 1, wherein the plurality of locations are arrayed in at least two dimensions within the layer.

3. The method of claim 2, wherein the plurality of locations are arrayed in three dimensions within the layer.

4. The method of claim 1, wherein the first coating material comprises silver vanadium oxide (SVO) and the second coating material comprises at least one of carbon fluoride, (CH₃F), carbon difluoride (CH₂F₂), carbon trifluoride (CHF₃) and carbon tetrafluoride (CF₄).

5. The method of claim 4, wherein the layer comprises a first surface adjacent the substrate and a second surface opposite the first surface, and wherein controlling at least one of the electrical conductivity, the thermal conductivity, the mechanical property, the power capability, the energy density, the chemical activity and the electrochemical activity at each of the plurality of locations within the layer comprises controlling the power capability and energy density by providing an increased concentration of the at least one of CH₃F, CH₂F₂, CHF₃ and CF₄ adjacent the first surface and providing an increased concentration of SVO adjacent the second surface.

6. The method of claim 1, wherein at least one of the first coating material and the second coating material comprises carbon.

7. The method of claim 1, wherein controlling at least one of the electrical conductivity, the thermal conductivity, the mechanical property, the power capability, the energy density, the chemical activity and the electrochemical activity at each of the plurality of locations within the layer comprises not printing at least one of the first coating composition and the second coating composition in at least one of the plurality of locations within the layer.

8. The method of claim 1, wherein controlling at least one of the electrical conductivity, the thermal conductivity, the mechanical property, the power capability, the energy density, the chemical activity and the electrochemical activity at each of the plurality of locations within the layer comprises controlling a stiffness of the layer.

9. The method of claim 1, further comprising heat treating the layer.

10. The method of claim 1, wherein the substrate comprises a non-planar substrate portion.

11. The method of claim 1, wherein the surface of the substrate comprises a first surface, wherein the layer comprises a first layer, wherein the substrate further comprises a second surface, and wherein the method further comprises:
printing a second layer on the second surface by ejecting the first coating composition and the second coating composition from the nozzle; and
controlling at least one of an electrical conductivity, a thermal conductivity, a mechanical property, a power capability, an energy density, a chemical activity and an electrochemical activity at each of the plurality of locations within the second layer by controlling a relative amount of the first coating material and the second coating material deposited at each of the plurality of locations within the second layer.

12. The method of claim 1, wherein the electrode comprises a first electrode, and wherein the method further comprises forming an electrode array by:
printing a layer of a second electrode on the substrate, wherein printing the layer of the second electrode comprises:
ejecting the first coating composition from the nozzle;
ejecting the second coating composition from the nozzle, wherein the first coating composition and the second coating composition are deposited on the substrate at a location different from the first electrode; and
controlling at least one of an electrical conductivity, a thermal conductivity, a mechanical property, a power capability, an energy density, a chemical activity and an electrochemical activity at each of a plurality of locations within the layer of the second electrode by controlling a relative amount of the first coating material and the second coating material deposited at each of the plurality of locations within the layer of the second electrode.

13. The method of claim 12, wherein the at least one of the electrical conductivity, the thermal conductivity, the mechanical property, the power capability, the energy density, the chemical activity and the electrochemical activity at each of the plurality of locations within the layer of the second electrode being different from the at least one of the electrical conductivity, the thermal conductivity, the mechanical property, the power capability, the energy density, the chemical activity and the electrochemical activity at each of the plurality of locations within the layer of the first electrode.

14. The method of claim 1, wherein the electrode comprises a patterned electrode.

15. The method of claim 1, wherein ejecting the first coating composition and the second coating composition from the nozzle comprises ejecting the first coating composition and the second coating composition from a single nozzle.

16. The method of claim 1, wherein ejecting the first coating composition and the second coating composition from the nozzle comprises ejecting the first coating composition from a first nozzle and ejecting the second coating composition from a second nozzle.

17. The method of claim 16, further comprising mixing the first coating composition and the second coating composition.

18-34. (canceled)

35. A computer-readable medium comprising instructions that cause a processor to:
introduce a first material and a second material over a substrate to form a layer of an electrode; and
control at least one of an electrical conductivity, a thermal conductivity, a mechanical property, a power capability, an energy density, a chemical activity and an electrochemical activity at each of a plurality of locations within the layer by controlling a relative amount of the first material and the second material deposited at each of a plurality of locations within the layer,
wherein the first material comprises SVO and the second material comprises at least one of CH₃F, CH₂F₂, CHF₃ and CF₄.

36. (canceled)

37. An electrode comprising a layer made by the method of claim 1, wherein the first coating material comprises silver vanadium oxide (SVO) and the second coating material comprises at least one of carbon fluoride (CH₃F), carbon difluoride (CH₂F₂), carbon trifluoride (CHF₃) and carbon tetrafluoride (CF₄).
